(19) United States
(12) Patent Application Publication
(10) Pub. No.: US 2012/0213032 A1
(43) Pub. Date: Aug. 23, 2012

(54) METHOD FOR PZ SUMMATION OF 3-DIMENSIONAL WIDE AZIMUTH RECEIVER GATHERS AND DEVICE

(75) Inventors: Philippe HERRMANN, Massy (FR); Pierre HUGONNET, Massy (FR)

(73) Assignee: CGGVERITAS SERVICES SA, Massy Cedex (FR)

(21) Appl. No.: 13/398,021

(22) Filed: Feb. 16, 2012

Related U.S. Application Data
(60) Provisional application No. 61/445,177, filed on Feb. 22, 2011.

(51) Int. Cl. G01V 1/38

(52) U.S. Cl. 367/24

(57) ABSTRACT

Apparatus, computer instructions and method for de-pegging seismic data related to a subsurface of a body of water. The method includes receiving as input recorded seismic data (H, G), wherein the recorded seismic data is recorded with a receiver having at least three components; extracting a three-dimensional (3D) gather from the recorded seismic data (H, G); separating up-going and down-going components (U, D) from the 3D gather using a 3D calibration operator (G_{cal}); and calculating de-pegged seismic data (P) based on the up-going and down-going components (U, D). The de-pegged seismic data (P) is calculated with no radon transform.

### CROSS REFERENCE TO RELATED APPLICATIONS

The present application is related to and claims the benefit of priority of U.S. Provisional Application No. 61/445,177, having the title “PZ Summation of 3D WAZ OBS Receiver Gathers,” and being authored by Hugonnet et al., the entire content of which is incorporated herein by reference.

### BACKGROUND

1. Technical Field

Embodiments of the subject matter disclosed herein generally relate to methods and systems and, more particularly, to mechanisms and techniques for 3-dimensional (3D) processing seismic data to separate up-going and down-going wave fields recorded by multi-component receivers underwater.

2. Discussion of the Background

Marine seismic data acquisition and processing generate a profile (image) of a geophysical structure under the seafloor. While this profile does not provide an accurate location of oil and gas reservoirs, it suggests, to those trained in the field, the presence or absence of these reservoirs. Thus, providing a high-resolution image of the geophysical structures under the seafloor is an ongoing process.

Reflection seismology is a method of geophysical exploration to determine the properties of earth's subsurface, which are especially helpful in the oil and gas industry. Marine reflection seismology is based on using a controlled source of energy that sends the energy into the earth. By measuring the time it takes for the reflections to come back to plural receivers, it is possible to evaluate the depth of the features causing such reflections. These features may be associated with subterranean hydrocarbon reservoirs.

A traditional system for generating the seismic waves and recording their reflections off the geological structures present in the subsurface is illustrated in FIG. 1. A vessel 10 tows an array of seismic receivers 11 provided on streamers 12. The streamers may be disposed horizontally, i.e., lying at a constant depth relative to a surface 14 of the ocean. The streamers may be disposed to have other than horizontal spatial arrangements. The vessel 10 also tows a seismic source array 16 that is configured to generate a seismic wave 18. The seismic wave 18 propagates downward toward the seafloor 20 and penetrates the seafloor until eventually a reflecting structure 22 (reflector) reflects the seismic wave. The reflected seismic wave 24 propagates upward until it is detected by the receiver 11 on the streamer 12. Based on the data collected by the receiver 11, an image of the subsurface is generated by further analyses of the collected data.

The seismic wave emitted by the source 16 may be substantially a spherical wave, e.g., it propagates in all directions starting from the source 16. Disturbances produced by the passing reflected seismic waves 24 (primary) are recorded by the various detectors 11 (the recorded signals are called traces), while disturbances produced by reflected seismic waves 26 (reflected at the water surface 14) are detected by the detectors 11 at a later time. Since the interface between the water and air is well approximated as a quasi-perfect reflector (i.e., the water surface acts as a mirror for the acoustic or seismic waves), the reflected waves 26 travel back toward the detector 11 as shown in FIG. 1. Waves 26 are normally referred to as ghost waves because these waves are due to a spurious reflection. The ghosts are also recorded by the detector 11, but with a different polarization, a different sign due to the -1 reflection coefficient at air water interface and a time lag relative to the primary wave 24.

Thus, every arrival of a marine seismic wave at detector 11 is accompanied by a ghost reflection. In other words, ghost arrivals trail their primary arrival and are generated when an upward traveling wave is recorded a first time on submerged equipment before being reflected at the surface-air contact. The now downward propagating reflected wave 26 is recorded a second time at detector 11 and constitutes the ghost. Primary and ghost (receiver side ghost and not the source side ghost) signals are also commonly referred to as up-going and down-going wave fields, respectively.

The time delay between an event and its ghost depends entirely upon the depth of the receiver 11, the wave velocity in water (this can be measured and considered to be approximately 1500 m/s), and the wave incidence angle. It can be only a few milliseconds for towed streamer data (depths of less than 15 meters) or up to hundreds of milliseconds for deep Ocean Bottom Cable (OBC) and Ocean Bottom Node (OBN) acquisitions. The degenerative effect that the ghost arrival has on seismic bandwidth and resolution is known. In essence, interference between primary and ghost arrivals causes notches or gaps in the frequency content, and these notches cannot be removed without the combined use of advanced acquisition and processing techniques.

One popular technique for separating the up-going and down-going wave fields is called PZ-summation and applies to both OBC/OBN and streamer data. Here, the seismic wave field is recorded using co-located hydrophones (P) and vertical geophones (Z). In other words, the detector 11 shown in FIG. 1 includes two different devices, the hydrophone 32 and the vertically-oriented geophone 34. Hydrophones measure pressure, whereas geophones measure particle velocity in the direction they are oriented. Data recorded on both receivers is in phase for up-going waves and of opposite phase for down-going waves, or the ghost. Combining both records involves a calibration to remove differences in frequency response, a unit conversion (which depends on the impedance, defined as the product of water density and wave velocity, of the water) and a time-offset dependant scaling to match amplitudes. After these steps, the data can be summed or subtracted to produce estimates of the up-going and down-going wave fields, respectively.

However, there are some limitations for the existing techniques that are now discussed. While wave field separation techniques for two components (2C) OBS data were described in the literature, Soubaras I (“Ocean bottom hydrophone and geophone processing,” SEG, Expanded Abstracts, 15, 24, 1996) proposed a 1D 3-step procedure (referred herein as PZ summation) for separating the up- and down-going components. The PZ summation first calibrated the geophone, then separated the up-going and down-going wave fields by summing the hydrophone and the calibrated geophone, and last attenuated the water-bottom peg-legs by adaptively subtracting the down-going from the up-going (considering wave fields just above the sea bottom). Later, Soubaras II (“Multiple attenuation of multicomponent ocean-bottom data according to an elastic model,” EAGE, Extended Abstracts, 1-16, 1999) extended the 1D technique to 2D.

With an arbitrary geology, only the receiver-side peg-legs are attenuated with the existing techniques. If the geology is 1D, both the source-side and the receiver-side peg-legs are attenuated because of the adaptive subtraction, but with a first-order amplitude approximation.

The extension of the 2D method to 3D gathers is possible by adapting the existing mono-channel implementations to a tau-px-py domain (using a radon transform) (see, for example, Soudani et al., “3D Methodology for OBC Pre-Processing,” EAGE, Extended Abstracts, B0144, 2006). However, the tau-px-py transforms can be demanding on the computing device that performs the calculations and prone to artifacts (e.g., due to spatial aliasing).

The remaining source-side peg-legs can, for example, be modeled using the 3D wave equation and adaptively subtracted, regardless of the geology, if a reflectivity model of the superficial layers is available (see, for example, Pica et al., “3D SRME on OBS data using waveform multiple modeling,” SEG, Expanded Abstracts, 25, no. 1, 2659-2663, 2006). The other surface multiples can finally be addressed by SRME if streamer data are available (see, for example, Ikelle L., “Combining two seismic experiments to attenuate free-surface multiples in OBC data,” Geophys. Prosp., 47, 179-193, 1999).

However, as discussed above, the classic 3D PZ summation method needs to perform calculations in the tau-px-py domain, which places a high toll on the existing computing devices. Thus, it would be desirable to provide a method that can process 3D gathers free of the tau-px-py transformations, and that can improve the source-side peg-leg attenuation.

### SUMMARY

According to an exemplary embodiment, there is a method for de- pegging seismic data related to a subsurface of a body of water. The method includes receiving as input recorded seismic data (H, G), wherein the recorded seismic data (H, G) is recorded with a receiver having at least three components; extracting a three-dimensional (3D) gather from the recorded seismic data (H, G); separating up-going and down-going components (U, D) from the 3D gather using a 3D calibration operator (G_{cal}); and calculating de-pegged seismic data (P) based on the up-going and down-going components (U, D). The de-pegged seismic data (P) is calculated with no radon transform.

According to another exemplary embodiment, there is a computing device for de-pegging seismic data related to a subsurface of a body of water. The device includes an interface configured to receive as input recorded seismic data (H, G), wherein the recorded seismic data (H, G) is recorded with a receiver having at least three components; and a processor connected to the interface. The processor is configured to extract a three-dimensional (3D) gather from the recorded seismic data (H, G), separate up-going and down-going components (U, D) from the 3D gather using a 3D calibration operator (G_{cal}), and calculate de-pegged seismic data (P) based on the up-going and down-going components (U, D). The de-pegged seismic data (P) is calculated with no radon transform.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional seismic data acquisition system with a horizontal streamer;

FIG. 2 is a schematic diagram illustrating a receiver-side peg-leg;

FIG. 3 is a schematic diagram illustrating up-going and down-going components recorded by a same receiver;

FIG. 4 is a schematic diagram illustrating a source-side peg leg;

FIGS. 5A-C are graphs illustrating de-pegged synthetic data having horizontal interfaces and using various methods according to an exemplary embodiment;

FIGS. 6A-C are graphs illustrating de-pegged synthetic data having non-horizontal interfaces and using various methods according to an exemplary embodiment;

FIGS. 7A-D are graphs illustrating de-pegged real data using various methods according to an exemplary embodiment;

FIGS. 8A-C are graphs illustrating the difference between a traditional approach and a novel approach according to an exemplary embodiment;

FIG. 9 is a flow chart illustrating a method for de-pegging recorded seismic data according to an exemplary embodiment; and

FIG. 10 is a schematic diagram of a computing device for implementing a method for de-pegging recorded seismic data.

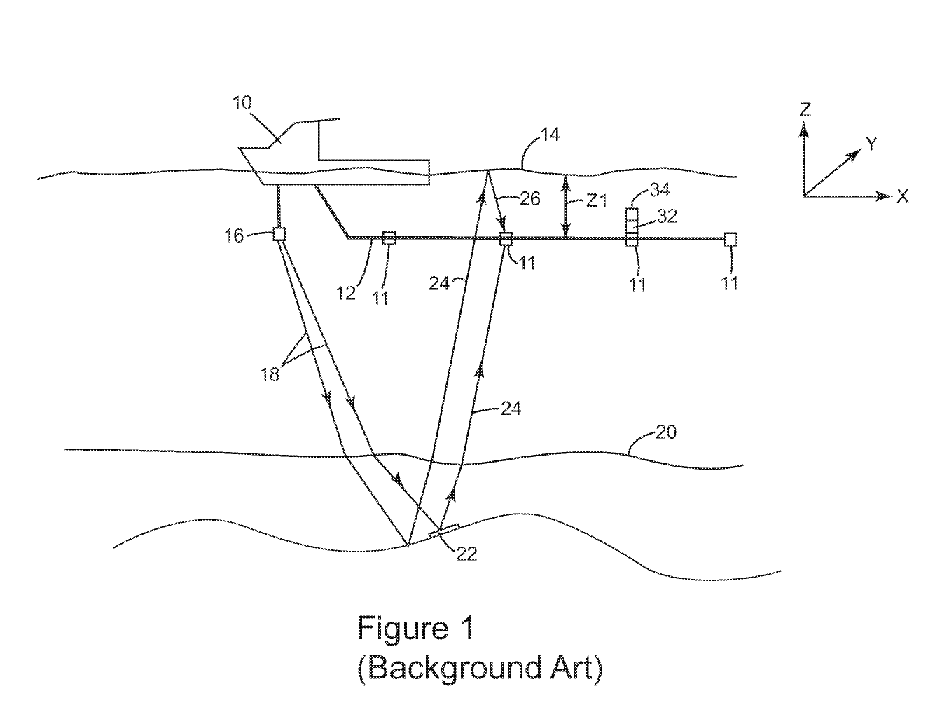

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of PZ summation algorithms for separating interfering up-going and down-going wave fields that are recorded by the same receivers. However, the embodiments to be discussed next are not limited to these dimensions, but may be extended to the X and Y directions, where the X, Y and Z directions determine a Cartesian system of reference.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, novel techniques are presented next that achieve up-down separation on OBS and/or marine streamer data. The techniques involve the recording of additional geophone (or other sensors, e.g., accelerometers) channels which measure particle velocity in a horizontal radial direction (X-component) and/or in a horizontal transverse direction (Y-component) besides the vertical direction (Z-component). The recorded 3D data is processed without the need for tau-px-py transforms. While existing methods may attenuate the source-side multiples (by relying on a first order approximation for the amplitudes and on the 1D geology assumption), by introducing a simultaneous 3D predictive deconvolution operator in the peg-leg attenuation formulation, the present embodiments remove the first order approximation, and the attenuation in the case of deviations from the 1D assumption is improved, as discussed later.

Before proceeding further with the novel embodiments, a brief discussion of a peg-leg is believed to be in order. A peg-leg may be defined as a multiply-reflected seismic energy, having, for example, an asymmetric path. The peg-leg amplitudes are added to primary reflections and they tend to come from shallow subsurface phenomena and highly cyclical deposition, and can be suppressed by seismic processing as discussed next. In some cases, the period of the peg-leg multiple is so brief that it interferes with primary reflections, and its interference causes a loss of high frequencies in the wavelet. Peg-leg multiple reflections may also be defined to be those multiples that undergo one reflection in the sedimentary sequence and other reflections in the near surface.

As the exemplary embodiments to be discussed next introduce novel deghosting techniques, synthetic data is used for illustrating the power of the new techniques. Synthetic data is defined as data generated, for example, on a computer, and it is considered to describe a possible subsurface. However, the synthetic data does not include measured data. The exemplary embodiments of deghosting techniques produce wave fields to be used for producing a final image of the subsurface. All these novel techniques are implemented in a computing device, for example, a processor, and the deghosted data is used to generate an image of the surveyed subsurface.

According to an exemplary embodiment, the up-going/down-going separation is obtained by summing/subtracting the calibrated geophone data to/from the hydrophone data. Cross-ghosting is a commonly used calibration method described in Soubaras I and II noted above. Such calibration is achieved by searching for a short matching filter g₀. Considering H to be the hydrophone recorded data, G the geophone recorded data, Z a water layer propagation operator, and I the unity matrix, the cross-ghosted versions H′ and G′ of H and G, respectively, are as follows:

H′=H·(I+Z), (1) and

G′=G·(I−Z), (2)

where (I+Z) and (I−Z) are the deterministic vertical velocity and pressure ghost operators. The filter g₀ is found by resolving equation:

g₀=argmin_{g}∥H′−g·G′∥². (3)

Having the filter g₀, the calibrated ghost G is determined based on:

G_{cal}=g₀·G. (4)

The up- and down-going operators U and D are determined as follows:

U=H+G_{cal} and D=H−G_{cal}. (5)

The above method is now extended to 3D receiver gathers, using true 3D filters and operators, and 3D convolutions. As a consequence, the 3D calibration operator matches not only the normal incidence response, but also the directivity diagram of the geophone to the hydrophone.

The propagation operator Z in equations (1)-(5) is 3D, but it is built assuming a locally 1D geology. However, if cross-ghosting is not required (e.g., for deep-water data, and in general when using an estimation window without multiples) the method is valid for any geology.

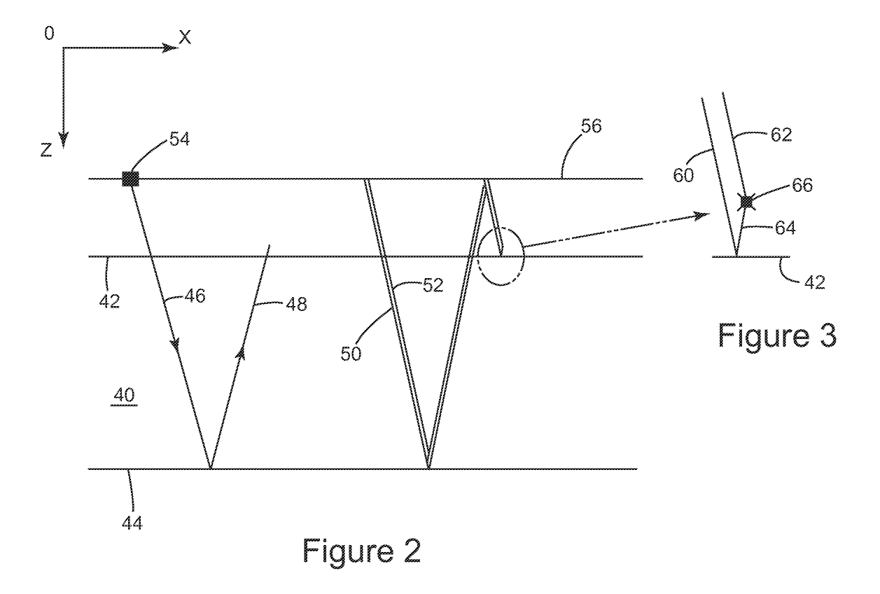

The above equations are now extended for 3D peg-leg attenuation. In addition, the equations are extended by incorporating a 3D predictive deconvolution operator. The receiver-side peg-leg attenuation is obtained by adaptively subtracting the down-going from the up-going as illustrated in FIGS. 2 and 3. FIG. 2 shows a subsurface 40 that is delimited by the ocean bottom 42. The subsurface 40 includes at least one reflection surface 44 from which a down-going wave 46 reflects and becomes an up-going wave 48. Two down-going waves 50 and 52 emitted from a source 54 are reflected at the reflection surface 44 and travel to the water surface 56. The waves are reflected at the water surface 56 because the water surface acts as a mirror surface for acoustic waves.

FIG. 3 shows how two down-going waves 60 and 62 travel toward a receiver 66 (that may be part of the OBC and may be configured to record the H and G data). The down-going wave 60 gets reflected at the ocean bottom 42 and an up-going wave 64 is formed. The receiver 66 records both the down-going (D) wave 60 and the up-going (U) wave 64. The down-going wave D is subtracted from the up-going wave U and a filter f₀ is determined as follows:

f₀=arg min_{f}∥U−f·D∥², and (6)

P=U−f₀·D, (7)

where P is the de-pegged data, and f₀ is a filter that represents the reflectivity of the (possibly complex) water bottom. It is noted that the example used herein to determine the above equations assumes that the receiver 66 is part of the OBC. However, the equations may be easily adapted for the situation when the receiver is part of a streamer. The filter f₀ may be 1D (Soubaras I), 2D (Soubaras II), and also 3D. In 3D, the filter f₀ contains the angle-of-incidence dependent reflectivity information (in 2D or 1D it is noted that all the waves are in a single plane, while in 3D each wave may be in a different plane, thus, the need of having the angle-of-incidence information). It is noted that any receiver-side peg-leg is present on both the up-going and down-going wave fields, while primaries (or source-side peg-legs) are present only on the up-going fields.

Equations (6) and (7), while being capable of handling 3D gathers, attenuate only the receiver-side peg-legs in the case of an arbitrary underlying geology. When the geology is close to 1D, the adaptive subtraction described above attenuates both the source-side and receiver-side peg-legs by overestimating f₀, but with a first order amplitude approximation (the full peg-leg attenuation requires a second order term).

Thus, according to an exemplary embodiment, a 3D predictive deconvolution operator F is introduced to specifically target the multiples. The predictive deconvolution operator F is simultaneously estimated with the reflectivity operator f as follows:

(f₀, F₀)=arg min_{f,F}∥(I+F)·(U−f·D)∥². (8)

Having determined F₀ and f₀, the de-pegged data P is given by:

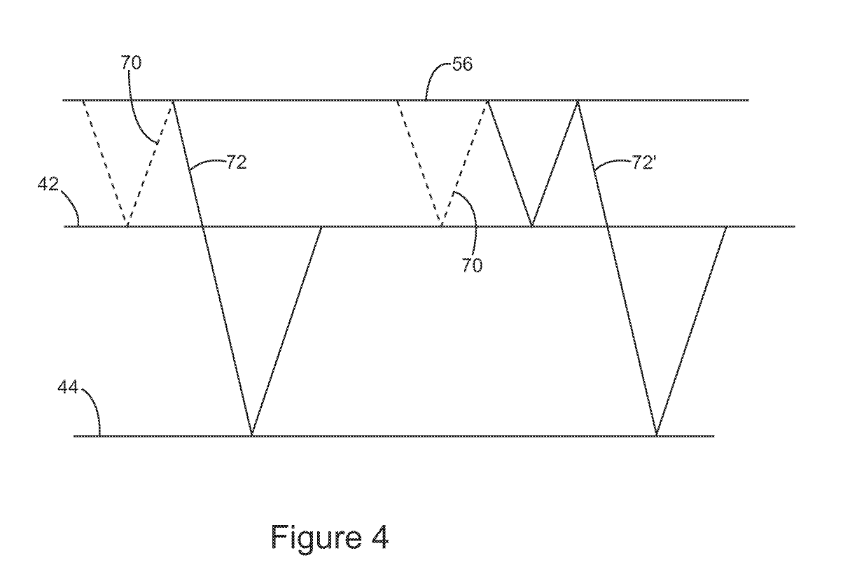

P=(I+F₀)·(U−f₀·D), (9)

where F₀ is the Green's function of the medium, as seen from the shot point (see, for example, FIG. 4). FIG. 4 illustrates that any source-side peg-leg can be predicted by applying a prediction operator 70 to a recorded event 72 and/or 72′. It is noted that when applied to a single receiver gather, the prediction given by F₀ is in theory valid only for a 1D geology. In practice, however, it is observed that the algorithm described by equations (8) and (9) is more tolerant to departures from this 1D assumption, because it has more degrees of freedom. For the perfect 1D case, the above-discussed algorithm provides an exact attenuation, due to the second order term (F₀·f₀·D), while the algorithm described by equations (6) and (7) cannot provide the exact attenuation.

The algorithm characterized by equations (8) and (9) is now tested based on synthetic data. The synthetic data includes a 3D receiver gather including 121×121 traces, the offset on x and the offset on y ranging from −1500 m to +1500 m. Three interfaces (reflectors 44 in FIG. 2) are defined at 200 ms, 480 ms, and 1120 ms, and all peg-legs are modeled. Only the up-going wave field U, on the central shot line at offset at y=0, is displayed.

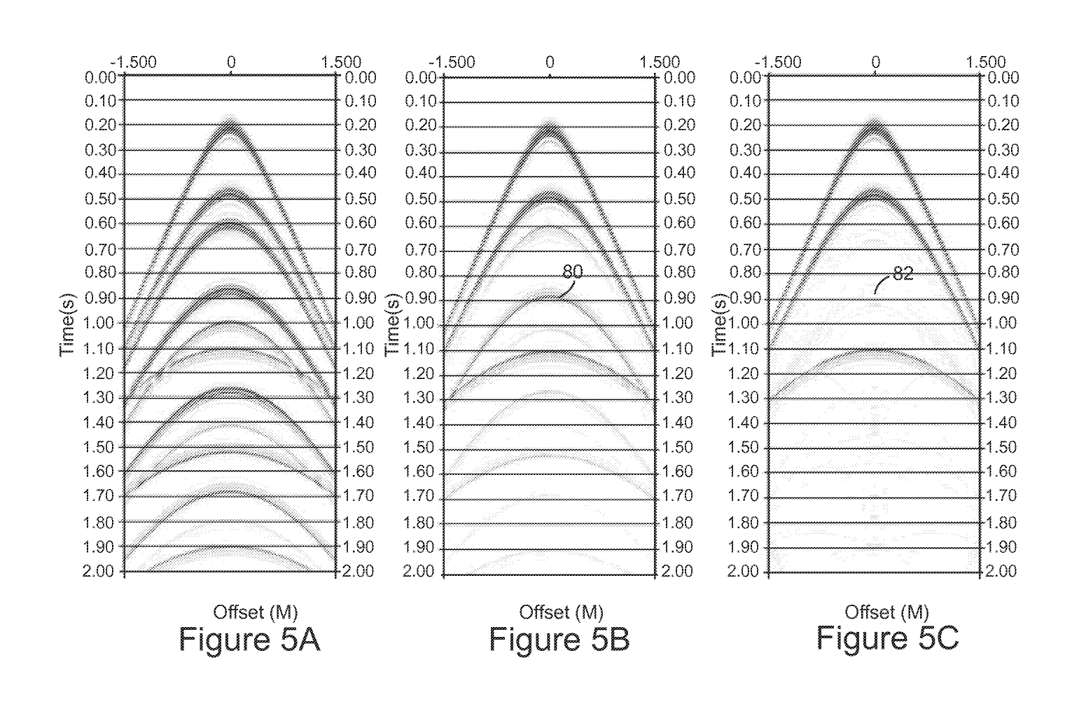

In a first test illustrated by FIGS. 5A-C, all the interfaces are horizontal. The up-going wave field for a central shot line is shown in FIG. 5A. The classic peg-leg attenuation (6)-(7), is illustrated in FIG. 5B, and leaves a significant amount of residual multiples, e.g., peg-leg 80. The source-side peg-legs are attenuated because they have exactly the same kinematics as the receiver-side ones (because the interfaces are horizontal), but the classic peg-leg attenuation cannot handle the exact amplitude series. In contrast, the deconvolution formulation described by equations (8) and (9) achieves an almost perfect attenuation as illustrated in FIG. 5C. It is noted that the peg-leg 82, which corresponds to the peg-leg 80, is barely visible in FIG. 5C.

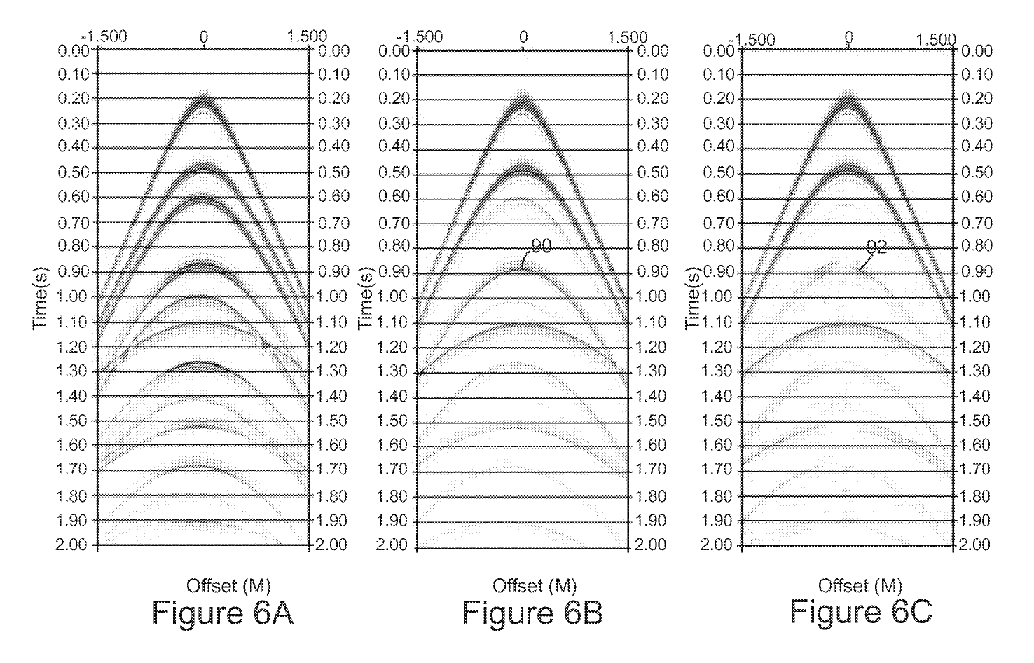

In a second test illustrated by FIGS. 6A-C, the water bottom (at 200 ms) has a 1-degree dip (i.e., inclination) along the X direction. This inclination is enough to introduce significant differences between the source-side and receiver side peg-legs. FIG. 6A illustrates the up-going wave field. As a result of the dip, the source-side peg-legs are almost entirely left in the data when the algorithm characterized by equations (6)-(7) is used as illustrated in FIG. 6B (see, for example, peg-leg 90). However, when the novel algorithm characterized by equations (8)-(9) is used, FIG. 6C shows that the de-pegged data does not include a part of the peg-legs left by the classic algorithm (see, for example, peg-leg 92 corresponding to peg-leg 90), and the improvement of the new algorithm over the classic algorithm is seen on the near offset traces, where the multiples stack well.

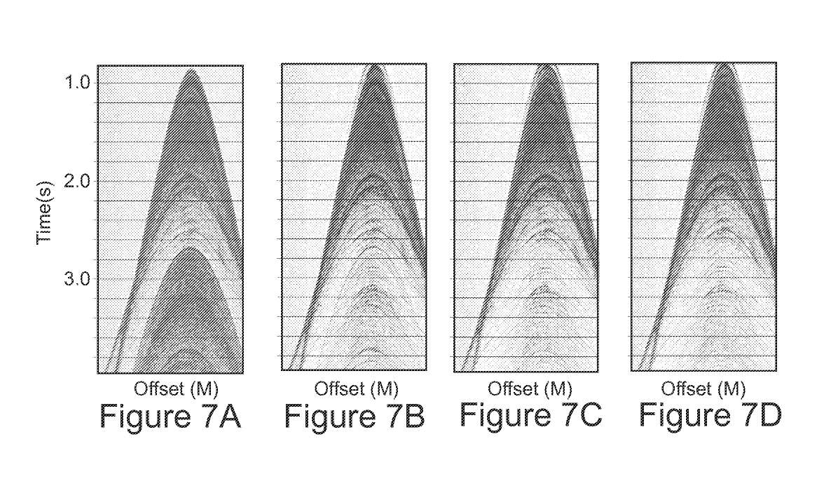

A real data example is illustrated in FIGS. 7A-D. FIG. 7A shows hydrophone recorded real data of a deep-water 3D OBN (node) receiver gather made of about 40,000 shots distributed on a 37.5 (m)×37.5 (m) surface grid. A central shot line at offset on y=0 is displayed in FIG. 7A. FIG. 7B shows the estimated up-going wave field using the algorithm characterized by equations (1)-(5), FIG. 7C shows the de-pegged up-going wave field obtained using the algorithm characterized by equations (6)-(7), and FIG. 7D shows the de-pegged up-going wave field obtained using the algorithm characterized by equations (8)-(9). Analyzing FIGS. 7A-D, it is noted that the peg-legs are best removed in FIG. 7D, which corresponds to the novel algorithm.

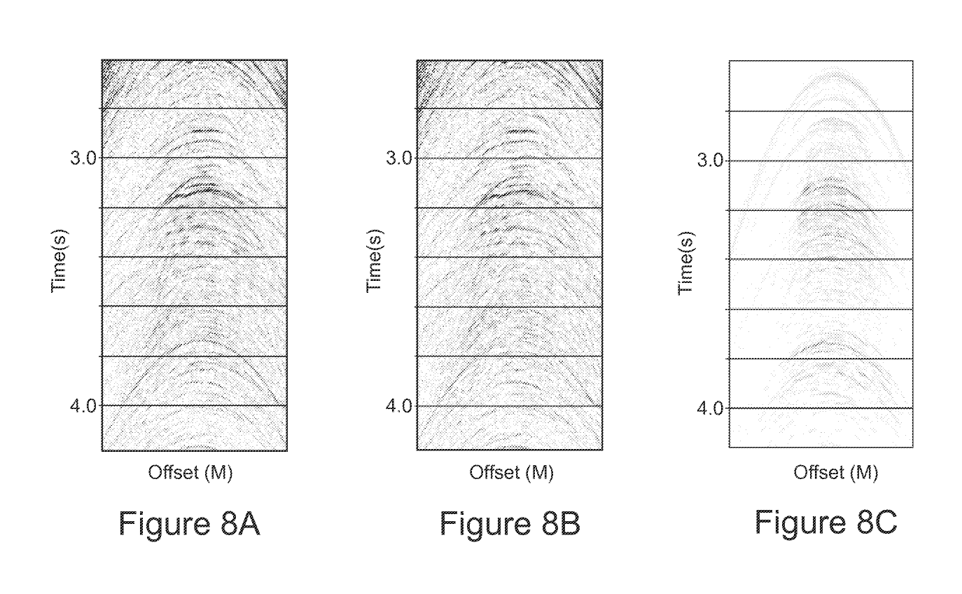

FIGS. 8A-C are close-ups of the peg-legs' contaminated part shown in FIGS. 7A-D. FIG. 8A corresponds to the de-pegged up-going wave field obtained using the algorithm characterized by equations (6)-(7), and FIG. 8B corresponds to the de-pegged up-going wave field obtained using the algorithm characterized by equations (8)-(9). The difference between the data illustrated in FIGS. 8A and 8B is shown in FIG. 8C. This difference is the extra peg-leg data removed by the novel algorithm.

Thus, one or more of the exemplary embodiments discussed above has advantageously extended to 3D receiver gathers the existing methods and algorithms of Soubaras I and II, i.e., method for up-going/down-going wave field separation and peg-leg attenuation of 2C OBS data. The 3D gathers can be processed in one pass with the novel approach, using full 3D operators, and without the need of splitting the operators into individual 2D shot lines or using tau-px-py transformations. In addition, the novel approach introduces a 3D predictive deconvolution operator for the peg-leg attenuation part that results in a better removal of peg-legs under a 1D assumption.

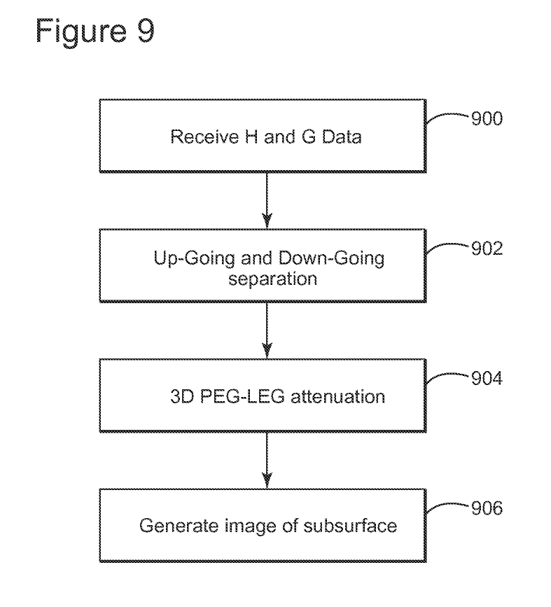

The novel algorithm discussed above is now discussed with regard to a flow chart that is illustrated in FIG. 9. FIG. 9 shows a step 900 in which seismic data is received for processing. The seismic data is recorded with a 3C or 4C receiver, either provided on a streamer or an OBC. The seismic data may include data H recorded by a hydrophone and data G recorded by a geophone. The processing device uses in step 902 the H and G data to separate the up- and down-going components U and D.

In step 904, the 3D peg-leg attenuation is calculated, i.e., de-pegged data P. The entire algorithm for determining the P data uses 3D operators and matrices, and there is no need for a radon transform or other transforms for dealing with 3D data. Further, a 3D predictive deconvolution operator F is introduced and used to de-peg the original data, both at a source-side and a receiver-side. This step may include plural sub-steps, as discussed with reference to equations (8) and (9).

The de-pegged data P obtained in step 904 may then be used in step 906, for example, to determine an image of the surveyed subsurface. Depending on the application and the need of the operator of the survey, the de-pegged data P may be used for other purposes.

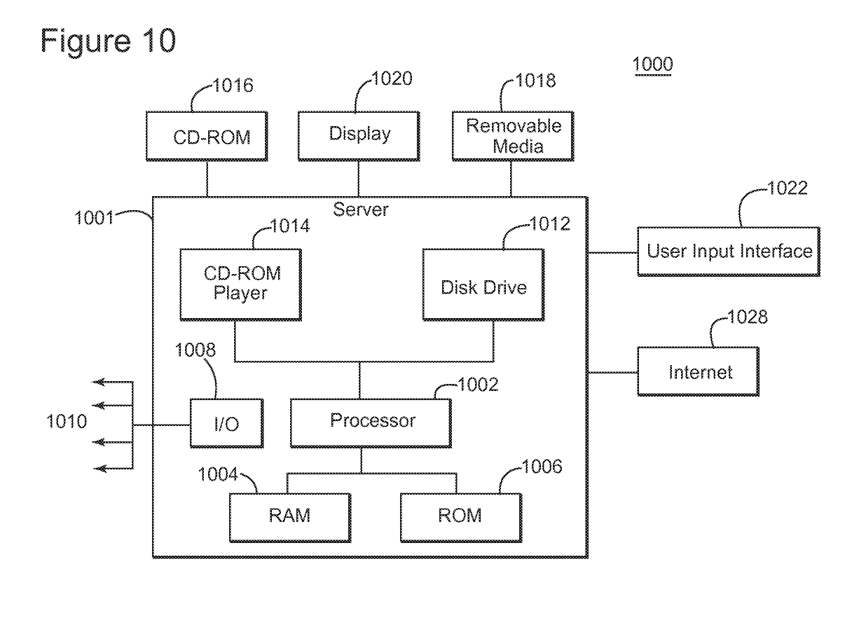

An example of a representative computing device capable of carrying out operations in accordance with the exemplary embodiments discussed above is illustrated in FIG. 10. Hardware, firmware, software or a combination thereof may be used to perform the various steps and operations described herein.

The exemplary computing device 1000 suitable for performing the activities described in the exemplary embodiments may include server 1001. Such a server 1001 may include a central processor unit (CPU) 1002 coupled to a random access memory (RAM) 1004 and to a read-only memory (ROM) 1006. The ROM 1006 may also be other types of storage media to store programs, such as programmable ROM (PROM), erasable PROM (EPROM), etc. The processor 1002 may communicate with other internal and external components through input/output (I/O) circuitry 1008 and bussing 1010, to provide control signals and the like. The processor 1002 carries out a variety of functions as are known in the art, as dictated by software and/or firmware instructions.

The server 1001 may also include one or more data storage devices, including hard disk drives 1012, CD-ROM drives 1014, and other hardware capable of reading and/or storing information such as a DVD, etc. In one embodiment, software for carrying out the above-discussed steps may be stored and distributed on a CD-ROM or DVD 1016, removable media 1018 or other form of media capable of portably storing information. These storage media may be inserted into, and read by, devices such as the CD-ROM drive 1014, the hard disk drive 1012, etc. The server 1001 may be coupled to a display 1020, which may be any type of known display or presentation screen, such as LCD or LED displays, plasma displays, cathode ray tubes (CRT), etc. A user input interface 1022 is provided, including one or more user interface mechanisms such as a mouse, keyboard, microphone, touch pad, touch screen, voice-recognition system, etc.

The server 1001 may be coupled to other computing devices via a network. The server may be part of a larger network configuration as in a global area network (GAN) such as the Internet 1028.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices, or magnetic storage devices such a floppy disk or magnetic tape. Other non-limiting examples of computer-readable media include flash-type memories or other known types of memories.

The disclosed exemplary embodiments provide an apparatus and a method for seismic data processing. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for de-pegging seismic data related to a subsurface of a body of water, the method comprising:
receiving as input recorded seismic data (H, G), wherein the recorded seismic data (H, G) is recorded with a receiver having at least three components;
extracting a three-dimensional (3D) gather from the recorded seismic data (H, G);
separating up-going and down-going components (U, D) from the 3D gather using a 3D calibration operator (G_{cal}); and
calculating de-pegged seismic data (P) based on the up-going and down-going components (U, D),
wherein the de-pegged seismic data (P) is calculated with no radon transform.

2. The method of claim 1, further comprising:
introducing a 3D predictive deconvolution operator (F₀) for calculating the de-pegged seismic data (P) such that both source-side and receiver-side peg-legs are removed from the recorded seismic data.

3. The method of claim 2, further comprising:
simultaneously estimating the 3D predictive deconvolution operator (F₀) and a filter function (f₀) based on the up-going and down-going components (U, D).

4. The method of claim 3, wherein the de-pegged seismic data (P) is given by:
P=(I+F₀)·(U−f₀·D),
where I is a unity operator.

5. The method of claim 3, wherein the 3D predictive deconvolution operator (F₀) is related to a medium in which the receiver is located and the filter function (f₀) is related to a reflectivity of the water bottom.

6. The method of claim 5, wherein the filter function (f₀) includes angle-of-incidence dependent reflectivity information.

7. The method of claim 1, wherein the recorded seismic data is wide-azimuth seismic data.

8. The method of claim 1, wherein the recorded seismic data is recorded with a receiver belonging to a streamer or an ocean bottom cable.

9. The method of claim 1, wherein the step of calculating de-pegged seismic data (P) based on the up-going and down-going components (U, D) is performed without splitting 3D operators into individual 2D operators.

10. The method of claim 1, further comprising:
using cross-ghosted versions (H′, G′) of the recorded seismic data (H, G) and a water layer propagation operator (Z) for calculating the up-going and down-going components (U, D),
wherein the water layer propagation operator (Z) is a 3D operator built assuming a locally 1D geology of the subsurface.

11. A computing device for de-pegging seismic data related to a subsurface of a body of water, the device comprising:
an interface configured to receive as input recorded seismic data (H, G), wherein the recorded seismic data (H, G) is recorded with a receiver having at least three components; and
a processor connected to the interface and configured to, extract a three-dimensional (3D) gather from the recorded seismic data (H, G),
separate up-going and down-going components (U, D) from the 3D gather using a 3D calibration operator (G_{cal}), and
calculate de-pegged seismic data (P) based on the up-going and down-going components (U, D),
wherein the de-pegged seismic data (P) is calculated with no radon transform.

12. The device of claim 11, wherein the processor is further configured to:
use a 3D predictive deconvolution operator (F₀) for calculating the de-pegged seismic data (P) such that both source-side and receiver-side peg-legs are removed from the recorded seismic data.

13. The device of claim 2, wherein the processor is further configured to:
simultaneously estimate the 3D predictive deconvolution operator (F₀) and a filter function (f₀) based on the up-going and down-going components (U, D).

14. The device of claim 13, wherein the de-pegged seismic data (P) is given by:
P=(I+F₀)·(U−f₀·D),
where I is a unity operator.

15. The device of claim 13, wherein the 3D predictive deconvolution operator (F₀) is related to a medium in which the receiver is located and the filter function (f₀) is related to a reflectivity of the water bottom.

16. The device of claim 15, wherein the filter function (f₀) includes angle-of-incidence dependent reflectivity information.

17. The device of claim 11, wherein the recorded seismic data is wide-azimuth seismic data.

18. The device of claim 11, wherein the recorded seismic data is recorded with a receiver belonging to a streamer or an ocean bottom cable.

19. The device of claim 11, wherein calculating de-pegged seismic data (P) based on the up-going and down-going components (U, D) is performed without splitting 3D operators into individual 2D operators, and the processor is further configured to use cross-ghosted versions (H′, G′) of the recorded seismic data (H, G) and a water layer propagation operator (Z) for calculating the up-going and down-going components (U, D),
wherein the water layer propagation operator (Z) is a 3D operator built assuming a locally 1D geology of the subsurface.

20. A computer readable medium including computer executable instructions, wherein the instructions, when executed by a processor, implement instructions for de-pegging seismic data related to a subsurface of a body of water, the instructions comprising:
receiving as input recorded seismic data (H, G), wherein the recorded seismic data is recorded with a receiver having at least three components;
extracting a three-dimensional (3D) gather from the recorded seismic data (H, G);
separating up-going and down-going components (U, D) from the 3D gather using a 3D calibration operator (G_{cal}); and
calculating de-pegged seismic data (P) based on the up-going and down-going components (U, D),
wherein the de-pegged seismic data (P) is calculated with no radon transform.
